(19) United States
(12) Patent Application Publication
(10) Pub. No.: US 2004/0020313 A1
(43) Pub. Date: Feb. 5, 2004

(54) Apparatus for effecting measurements on the geometry of motor vehicle suspensions

(76) Inventor: Eride Rossato, Mirano (IT)

Correspondence Address: HOFFMAN WASSON & GITLER, 2361 JEFFERSON DAVIS HIGHWAY, SUITE 522, ARLINGTON, VA, 22202

(21) Appl. No.: 10/399,050

(22) PCT Filed: Sep. 13, 2001
(86) PCT No.: PCT/EP01/10556

(30) Foreign Application Priority Data
Oct. 23, 2000 (IT) VE2000A00043

(51) Int. Cl. G01B 5/255

(52) U.S. Cl. 73/865.9; 33/203.13; 33/533

(57) ABSTRACT

An apparatus for effecting measurements on the geometry of the suspensions of a motor vehicle, to be applied to a vehicle lift, characterised by comprising on at least one runway (4), in a position corresponding with at least one wheel (12, 4 0), a pair of rollers (20, 22; 50, 52) which substantially do not project from the runway surface when at rest, but can be raised to adhere to said wheel (12, 40) on opposite sides of the region of contact with said runway, said pair of rollers (20, 22; 50, 52) being associated with means (26, 36; 42, 68) for causing them to translate, when raised, along the corresponding runway (4).

This invention relates to an apparatus for effecting measurements on the geometry of motor vehicle suspensions, and more particularly an apparatus which enables measurements to be effected on the alignment, the attitude and the convergence of motor vehicle wheels, using suitable instrumentation.

Apparatus for effecting measurements on the geometry of motor vehicle suspensions are known from EP-A2-0215540; they are generally applied to the runways of a vehicle lift, onto which a motor vehicle has been previously driven, and comprise for each runway a plate housed in a cavity formed in the runway and having a depth such as to ensure coplanarity between said plate and the runway surface. The plate rests on the base of said cavity via a plurality of spherical supports, so that when one of the front wheels of the vehicle rests on the plate, the plate can arrange itself freely in accordance with the thrusts received by said wheel. Suitable instruments applied to the wheel and interacting with electronic equipment are able to determine the characteristics which overall define the geometry of the suspensions.

In order to identify inevitable errors in the positioning of these instruments relative to the wheels, and to automatically compensate these errors, the wheels to which these instruments are applied are rotated slowly and uniformly through a certain angle during the measurements. This can be done by manually rotating the wheels after raising them from the runways or by rotating them along said resting surface. In the first case, means must be provided for raising the wheels, and hence the vehicle, above the runways, whereas in the second case the vehicle has to be moved along the runways through a certain distance.

The present invention provides an apparatus for effecting measurements on the geometry of the suspensions of a motor vehicle which does not require means for raising the vehicle from the runways, but bases its operation on the rolling of the wheels along the runways.

With the known apparatus of this type, this rolling is achieved by manually pushing the vehicle along the runways, this being a slow, uncomfortable and tiring operation which in addition does not allow any automation.

DE-A-19841944 discloses a device having two rollers, on which the vehicle tires can be made to rotate. A wheel contact plate is arranged between the rollers over a shock-absorbing device. The rollers can be freely or forcedly moved axially. The rollers and the wheel contact plate can be moved with respect to each other in the vertical direction. Devices are provided to move the axial displacement and the rotation of the rollers.

An object of the invention is to effect measurements on the geometry of motor vehicle suspensions in a correct and rigorously repetitive manner.

Another object of the invention is to effect these measurements without requiring the operator to perform uncomfortable, laborious and difficult manoeuvres.

A further object of the invention is to effect these measurements automatically, independently of the vehicle wheel base.

All these and further objects which will be apparent from the ensuing description are attained, according to the invention, by an apparatus for effecting measurements on the geometry of the suspensions of a motor vehicle, to be applied to a vehicle lift, as described in claim 1.

Two preferred embodiments and some variants of the present invention are described in detail hereinafter with reference to the accompanying drawings, in which:

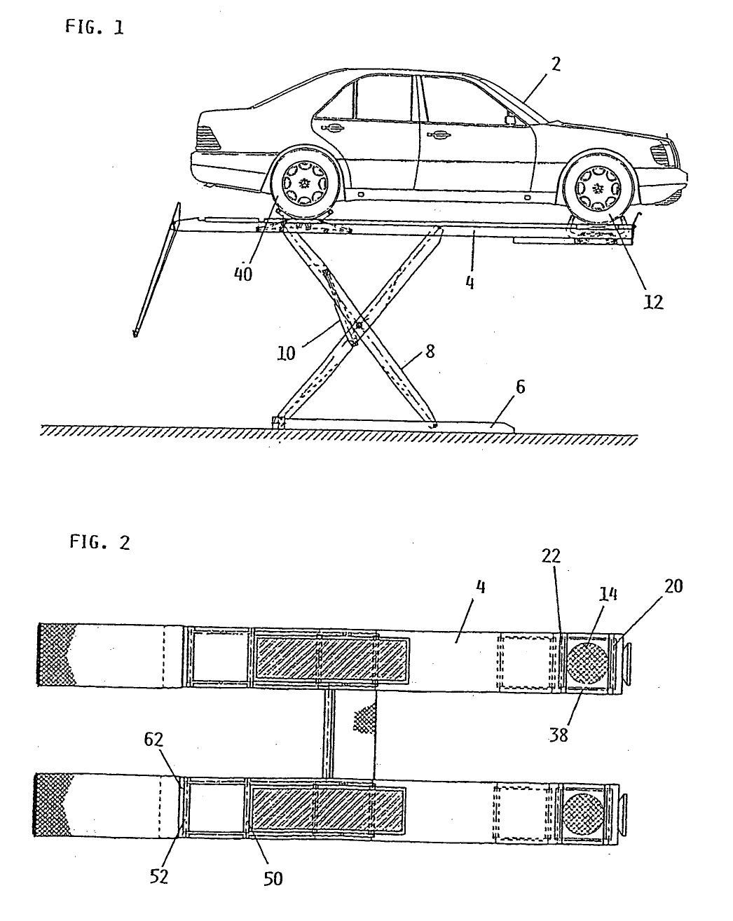

FIG. 1 is a side view of a vehicle lift, on which the motor vehicle being measured is positioned,

FIG. 2 is a plane view thereof without the vehicle,

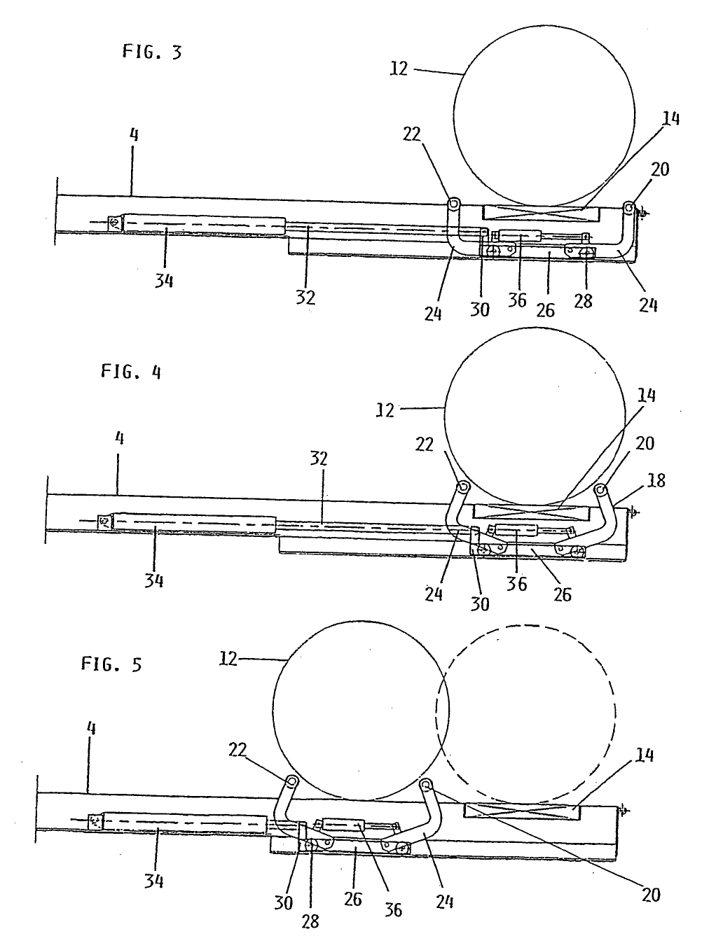

FIG. 3 is an enlarged vertical section through the front portion of a runway, to which the apparatus of the invention, shown in its rest condition, is applied,

FIG. 4 shows it in an intermediate measurement stage,

FIG. 5 shows it in a subsequent measurement stage,

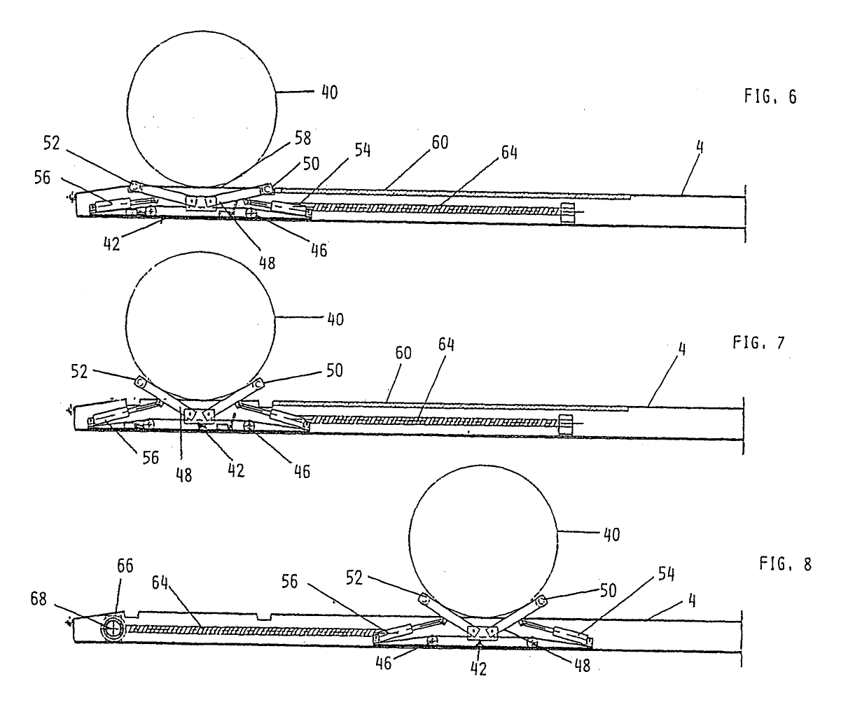

FIG. 6 is a different embodiment of the apparatus of the invention, provided for application to the rear part of the runways of a vehicle lift, and shown in the rest condition,

FIG. 7 shows it in the same view as FIG. 5 in an intermediate measurement stage, and

FIG. 8 shows it in a successive measurement stage.

As can be seen from the figures, the apparatus of the invention is mounted on a vehicle lift comprising a pair of runways 4 which can be lifted above longitudinal base members 6 by articulated pantograph arms 8 and lifting members 10 applied to them.

In the embodiment shown in FIG. 3 to 5, the apparatus of the invention is intended to be applied only to the front wheels 12 of the vehicle 2, on traditional ball plates 14 housed in recesses provided in each runway 4 and formed of a depth such as to ensure coplanarity between the upper surface of the plate 14 and the surface of the runway 4.

To the front and rear of each ball plate 14, the surface of the runway 4 comprises a pair of transverse rectangular apertures 18 of dimensions suitable to enable each to house a roller 20, 22 idly supported by a pair of arcuate arms 24. The arcuate arms of each pair are hinged to a carriage 26 provided with rollers 28 for sliding along the bottom of the respective runway 4.

The carriage 26 is connected via a bracket 30 to the rod 32 of a hydraulic cylinder-piston unit 34 secured to the bottom of the runway 4.

The two pairs of arms 24 supporting the rollers 20, 22 are connected together by a pneumatic actuator 36, which, either on manual command by the operator or automatically, shifts the rollers from a lower position practically housed within the rectangular apertures 18, to an upper position in which they rest against the front wheel 12 of the vehicle 2.

The surface of the runway 4 is also provided with longitudinal slits 38 enabling the pairs of arcuate arms 24 to pass freely, when in their raised condition, while the carriage 26 moves along the runway 4, driven by the hydraulic actuator 34.

The operation of this embodiment of the apparatus of the invention is as follows:

the motor vehicle 2 is made to advance along the runways 4 until its front wheels 12 are positioned on the two ball plates 14. In this condition the ball plates 14 are released from the runways 4, so that their spherical supports enable them to locate freely in accordance with the stresses received from the wheels. After effecting the measurements in the traditional manner, a command is fed to the actuators 36, which raise the arcuate arms 24 until the respective rollers 20, 22 adhere to the wheels 12. At this point an automatic command fed to the two hydraulic actuators 34 causes the vehicle 32 to slide along the runways 4, so that the wheels 12 roll along the surface of these for a predetermined distance.

During this sliding travel, the instruments applied to the wheels effect the scheduled measurements.

On termination of this operation, an inverse command is fed to the actuators 34, which return the carriages 26, and hence the vehicle 2, to the initial position, before a further command is fed to the actuators 36 to return the idle rollers to their rest condition and to enable the vehicle 32 to then descend from the vehicle lift.

In the aforedescribed embodiment, the ball plates 14 are of diameter less than the axial length of the rollers 20, 22, this length being less than the width of the runways 4. However in a variant not shown in the drawings, the axial length of the rollers 20, 22 is greater than the width of the runways 4, in which case the longitudinal slits for passage of the pairs of arcuate arms 24 are formed in the sides of the runways.

According to a further embodiment, the actuators for moving the carriages 26 are not of hydraulic type but instead of electromechanical type, i.e. consisting of a threaded bush operated by an electric motor fixed to the runway and coupled to a threaded shaft fixed to the carriage.

The embodiment shown in FIGS. 6 to 8 is intended to act on the rear wheels 40 of the vehicle 2. For this purpose in the rear part of each runway 4 there is provided a carriage 42 comprising a rigid base frame provided with idle rollers 46 for sliding along the bottom of the runway. Two pairs of arms 48 are hinged to the base frame, each supporting an idle roller 50, 52 and connected to the frame via its own actuator 54, which can be fed independently of the actuator 56 of the other pair.

In a more forward position than the front roller 50, there is provided in each runway 2 a recess 60 housing a rectangular plate 58, for example of the type described in EP-B1-0 051 088. It is provided with spherical supports, which maintain it coplanar with the remaining surface of the runway.

This recess 60 extends longitudinally to involve a length of the runway 4 suitable to enable the apparatus of the invention to be used, as will be apparent hereinafter, with motor vehicles of different type and more specifically of different wheel base.

More particularly, the length of said recess 60 is such that when a vehicle 2 is positioned with its front wheels 12 in proximity to the front end of the runways 4 and in particular on ball plates 14 of the type indicated in the preceding embodiment, the rear wheels 40 fall on said plate 58, independently of the wheel base of the vehicle 2.

The carriage 42 with the arms 48 and the actuators 54, 56 is associated with a threaded shaft 64 engaged in a threaded bush 66 coupled to an electric motor 68. The combination is slidable along a guide provided on the bottom of the relative runway 4, along which the motor 68 and the bush 66 can be locked by traditional methods, for example electromagnets, by external command.

Instead of being electromechanical by means of the motor 68, bush 66 and threaded shaft 64, the connection between the carriage 42 and runway 4 can be hydraulic, as for the front carriage 26, by means of a cylinder-piston unit, of which the rod is compiled to the carriage 42 and the cylinder can be locked in the desired position along the runway 4.

The operation of this second embodiment of the apparatus according to the invention is as follows:

when in the rest condition each carriage 42 is in its rear end-of-travel position with the rollers 50, 52 lowered and housed in the corresponding apertures 62 provided in the respective runway 4.

In this condition, when a motor vehicle 2 is driven onto said runway 4, each front wheel 12 on passing over the front roller 50 of the relative carriage 42 operates a microswitch, resulting in the actuator 54 being fed to consequently raise this roller.

Following this raising, when the vehicle rear wheels 40 make contact with the raised rollers 50, they drag the respective carriages 42 along the subsequent advancement and rolling runway on the plates 58.

The advancement travel of the vehicle 2 halts when its front wheels 12 reach the front end of the respective runway, from which moment the measurement can be effected in traditional manner with the vehicle at rest. The actuators 56 of the rear support arms 48 are then fed, until these arms adhere to the respective wheel 40, but without raising it from the plate 58.

The electric motor 68 is then locked onto the bottom of the runway 4, and then powered to drag the vehicle rearwards along the runways, to effect those measurements required during the rolling of the wheels.

These measurements having been effected, the two actuators 54, 56 of each carriage are deactivated, to return the two rollers 50, 52 to rest and enable the vehicle 2 to then descend from the lift runways 4.

The vehicle lift can be equipped with apparatus to effect the measurement on only the front wheels, on only the rear wheels, or on both.

In all cases, it is apparent that the apparatus of the invention is particularly advantageous, and in particular:

it is applicable to practically any type of vehicle lift,

it enables the measurement of the vehicle suspension geometry to be effected in a correct and rigorously repetitive manner,

it enables this measurement to be effected without requiring uncomfortable or laborious manoeuvres form the operator,

it enables this measurement to be effected on different vehicles with automatic adaptation to their wheel bases.

1. An apparatus for effecting measurements on the geometry of the suspensions of a motor vehicle, to be applied to a vehicle lift, comprising on at least one runway (4), in a position corresponding with at least one wheel (12, 40), a pair of rollers (20, 22; 50, 52) which substantially do not project from the runway surface when at rest, but can be raised to adhere to said wheel (12, 40) on opposite sides of the region of contact of said wheel with said runway, characterised in that said pair of rollers (20, 22; 50, 52) have their axis arranged transversely with respect to the longitudinal axis of the runway and are associated with means (26, 36; 42, 68) which cause them to contemporaneously translate, when raised, along the longitudinal axis of the corresponding runway (4).

2. An apparatus as claimed in claim 1, characterised by comprising on each runway (4) a pair of rollers (20, 22; 50, 52) in positions corresponding with at least one pair of corresponding wheels (12, 40).

3. An apparatus as claimed in claim 1, characterised in that the roller of each pair of rollers (20, 22; 50, 52) is mounted idly on a pair of arms (24; 48) associated with means for moving them in the sense of causing the roller to rise.

4. An apparatus as claimed in claim 3, characterised in that the arms (24) of each pair of rollers (20, 22) are associated with a single actuator (36).

5. An apparatus as claimed in claim 3, characterised in that the arms (48) of each pair of rollers (50, 52) are associated with actuators (54, 56) controllable independently of each other.

6. An apparatus as claimed in claim 3, characterised in that the runway (4) comprises a pair of transverse apertures (18; 62) for housing the rollers (20, 22; 50, 52) when in their lowered condition.

7. An apparatus as claimed in claim 3, characterised in that the pair of arms (24; 48) for supporting and shifting the rollers (20, 22; 50, 52) are hinged to a carriage (26; 42) slidable along the bottom of the runway (4).

8. An apparatus as claimed in claim 7, characterised by comprising a hydraulic actuator (34) for moving each carriage (26; 42) along the corresponding runway (4).

9. An apparatus as claimed in claim 7, characterised by comprising an electromagnetic actuator with a threaded shaft (64) and motorised threaded bush for moving each carriage (26; 42) along the corresponding runway (4).

10. An apparatus as claimed in claim 3, characterised in that each runway (4) comprises longitudinal slits (38) for passage of the arms (24; 48) supporting the rollers (20, 22; 50, 52) during their translation along the runway.

11. An apparatus as claimed in claims 4 and 6, characterised in that each runway (4) comprises, between the two transverse apertures (18) housing the rollers (20, 22), a recess (16) for housing a rotary plate (14) coplanar with the surface of said runway.

12. An apparatus as claimed in claims 5, 6 and 11, characterised in that each runway (4) comprises, downstream of the pair of rollers (50, 52), a recess (60) for housing a plate (58) mounted on spherical supports and coplanar with the surface of said runway, the length of said plate (58) being such as to ensure that the rear wheels (40) practically of any motor vehicle (2) rest thereon when the vehicle front wheels rest on said rotary plates (14).
